(19) United States
(12) Patent Application Publication
(10) Pub. No.: US 2012/0235785 A1
(43) Pub. Date: Sep. 20, 2012

(54) WIRELESS COMMUNICATION DEVICE AND METHOD WITH INTELLIGENT AUTHENTICATION

(75) Inventors: William P. Alberth, Prairie Grove, IL (US); William S. Hede, Lake in the Hills, IL (US)

(73) Assignee: MOTOROLA MOBILITY, INC., Libertyville, IL (US)

(21) Appl. No.: 13/050,173

(22) Filed: Mar. 17, 2011

(51) Int. Cl. G05B 19/00

(52) U.S. Cl. 340/5.8

(57) ABSTRACT

A wireless communication device (200) and method (300) with intelligent authentication. The method (300) can include the steps of: capturing (310) a first image of an object; determining (320) whether the object matches a predetermined criteria; projecting (330) ultra violet illumination at the object and capturing a second image of the object; and comparing (340) the second image to a reference file, to determine purported authenticity of the object. The device (200) and method (300) can provide an improvement in minimizing the spread of counterfeit currency and use of non-authentic documents, in near real time and in a portable device.

### BACKGROUND

1. Field

The present disclosure relates to a wireless communication method and device with intelligent authentication.

2. Introduction

Users enjoy portable electronic devices and wireless communication devices. Innovative features and functions are embraced by the user community.

There is a need for a wireless communication method and device with intelligent authentication. It is becoming more common nowadays, that currency counterfeiters are attempting to pass off even low value currencies. And, when this happens, a proprietor takes the loss for counterfeit bills. A proprietor would welcome a portable device, such as a cell phone, computing device, tablet and the like, that could be used to authenticate currency and important documents.

There is a need for a wireless communication method and device adapted for authenticating currency.

There is a need for a wireless communication method and device adapted for authenticating important documents, such as passports, identification cards, credit cards and driver's licenses, typically with UV seals. For example, a bar owner would welcome a simple and accurate way to detect and reject underage patrons attempting to gain entry.

Thus, a method and device that addresses these kinds of problems would be considered an improvement in the art.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment.

FIG. 2 is an exemplary block diagram of a device according to one embodiment.

FIG. 3 is an exemplary block diagram of a wireless communication method with intelligent authentication according to one embodiment.

### DETAILED DESCRIPTION

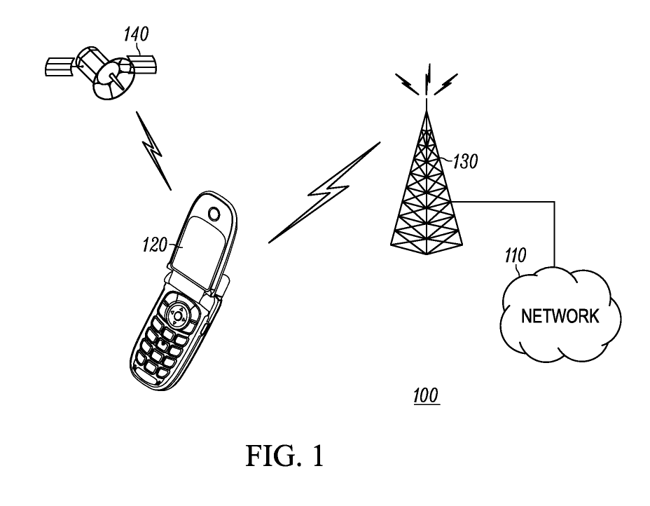

FIG. 1 is an exemplary block diagram of a system 100 according to one embodiment. The system 100 can include a network 110, a terminal 120, and a base station 130. The terminal 120 may be a wireless communication device, such as a wireless telephone, a cellular telephone, a personal digital assistant, a pager, a personal computer, a wireless pad, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can communicate with the network 110 and with other devices on the network 110 by sending and receiving wireless signals via the base station 130, which may also comprise local area, and/or personal area access points. The terminal 120 is shown being in communication with a global positioning system (GPS) 140 satellite, global navigation satellite system (GNSS) or the like, for position sensing and determination.

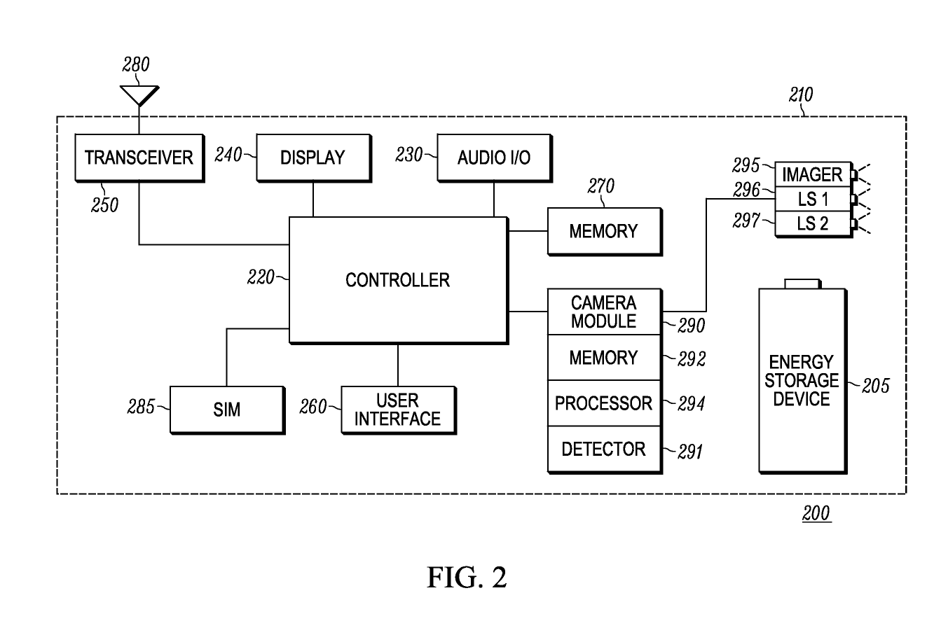

FIG. 2 is an exemplary block diagram of a wireless communication device 200 configured with an energy storage device 205, such as in the terminal 120, or in a wireless communication device, for example. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220.

As shown in FIG. 2, the wireless communication device 200 further includes an intelligent camera module 290 including an imager 295, a first light source 296 and a second light source 297, such as an ultra violet light source. The intelligent camera module 290 can be configured to: capture a first image of an object; determine whether the object matches a predetermined criteria; project ultra violet illumination at the object and capture a second image of the object; and compare the second image to a reference file, to determine purported authenticity of the object. The camera module 290 in FIG. 2 is further shown with a detector module 291 configured for image recognition, a memory module 292, a processor 294, as detailed below.

In one embodiment, the camera module 290 is capable of being in communication with GPS, GNSS, cellular tower, and alike, and a processor module 294, coupled to the controller 220. In more detail, the camera module 290 can reside within the controller 220, can reside within the memory 270, can be an autonomous module, can be software, can be hardware, or can be in any other format useful for a module on a wireless communication device 200.

The display 240 can be a liquid crystal display (LCD), a light emitting diode (LED) display, a touch screen display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory or any other memory that can be coupled to a wireless communication device.

In more detail, the wireless communication device 200 shown in FIG. 2, can include: a housing 210; a controller 220 coupled to the housing 210, the controller 220 configured to control the operations of the wireless communication device and to provide ancillary computing operations which may be unrelated to wireless communications such as audio or video processing, application processing and the like. Advantageously, the wireless communication device 200 can provide an improvement in minimizing the spread of counterfeit currency and use of non-authentic documents, real time, and in a portable device.

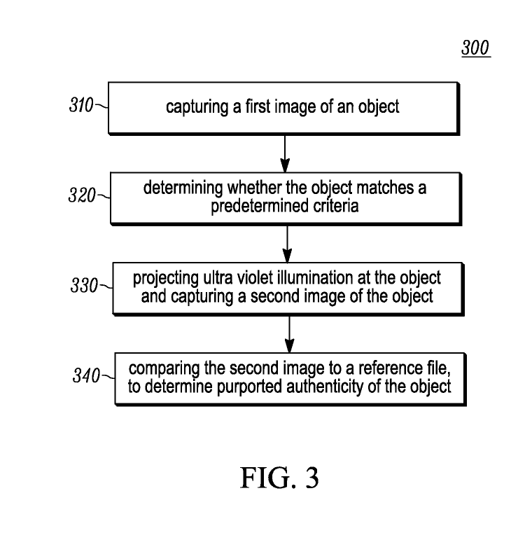

A block diagram of a wireless communication method 300 is shown in FIG. 3. In its simplest form, the method 300 can include the steps of: capturing 310 a first image of an object; determining 320 whether the object matches a predetermined criteria; projecting 330 ultra violet illumination at the object and capturing a second image of the object; and comparing 340 the second image to a reference file, to determine purported authenticity of the object. Advantageously, the method 300 can provide an improvement in minimizing the spread of counterfeit currency and use of non-authentic documents, in real time and in a portable device.

The step 320 may include matching an object in the first image to a known document (currency, driver's license, passport, etc). Step 320 may also include determining that certain objects are not in the picture, such as a face. In one embodiment, it may be desirable not to illuminate a person with UV light. Therefore, the criteria may include that a face not be in the first image. It is expected that the picture of a face, such as in a drivers license, is an acceptable criteria, however a real face in the picture may not be an acceptable criteria.

Step 320 of projecting UV illumination and taking a second image may happen without further UI input from the user if the predetermined criteria of step 320 is met.

The step of comparing the first and second image 340 may occur in the device 120 or in the network 110, or in a combination of the two.

In one embodiment, the object being examined for authenticity, includes an identifier viewable under UV illumination, such as for example, an ultra violet seal typically found on credit cards, pass ports, identification cards and currency.

In a preferred embodiment, the comparing step 340 can include optical recognition which can include image recognition, character recognition, visual recognition, facial recognition, color recognition, shape recognition and the like. This can be accomplished by use of the detector module 291 in FIG. 2, for example. Advantageously, the comparing step 340 can include optical recognition detecting, to check against a reference file, to confirm a threshold authenticity such that the optically recognized image matches the reference file, as detailed herein. For example, the comparing step 340 compares to pre-determined like objects, which can provide an authenticity score, to ascertain whether a threshold score is met. Beneficially, optical recognition and authenticity scoring can improve counterfeit detection.

In one embodiment, the comparing step 340 further includes calculating a score and displaying a result. For example, a color such as red, a stop sign image or any pass fail indication can be presented to a user on a display, for real time results.

The method 300 can further comprise providing a passing mode wherein a prompt indicates the predetermined criteria has matched and a failing mode indicating the predetermined criteria has not matched, relative to the determining step 320. Preferably, a prompt indicates or confirms that it is appropriate to proceed, that is to capture the second image. For example, after taking a first picture with a predetermined criteria that has matched, a user is prompted to proceed, to take a second with UV illumination. It is also expected that the second picture could be automatically taken by the device after the predetermined criteria has been met.

In one use case, the predefined criteria in the determining step 320, relates to at least one of a currency, a credit card, a passport, a drivers license and an identification card. For example, the predefined criteria could include an image of a president for currency, a certain font, certain characters, a certain color, a certain geometric size, a certain shape and the like.

The projecting ultra violet illumination step 330 using light source two 297 in FIG. 2, for example, can include a focused flash. Preferably, the focused and strategically directed flash, is pointed at an identifier viewable under UV illumination, for minimal dispersion to unwanted areas and minimal power drain.

In one use case, when the object is one of a passport, a credit card, a drivers license and an identification card (hereafter document), a third image of a purported owner can be captured. This feature can provide a record of one trying to use a non-authentic, counterfeit or failed document, for the record, if needed. For example, if an underage person tried to gain access to a bar, a record would be made of that persons attempted entry. Thus, the record could include three images, be date and time stamped, include an authenticity score, for the record. For example, the first image could be an image of an ID card or passport, a second image could be the ID Card or passport under UV illumination and the third a picture of the purported owner. In one embodiment, a user can be prompted to focus the camera on the purported owner, for enhanced automation.

In another case, if the object is one of a passport, a drivers license and an identification card, a third picture can automatically be taken when facial recognition senses that a face is framed in the camera, for enhanced ease of use.

In another embodiment, a wireless communication device 200 is disclosed. It can include: a housing 210 including a display 240; a controller 220 coupled to the housing 210, the controller 220 configured to control the operations of a wireless communication device; and an intelligent camera module 290 including an imager 295, a light source 296 and a second light source 297, such as an ultra violet light source. The intelligent camera module 290 is configured to: capture a first image of an object; determine whether the object matches a predetermined criteria; project ultra violet illumination at the object and capture a second image of the object; and compare the second image to a reference file. Advantageously, the wireless communication device 200 can determine purported authenticity of the object.

In a preferred embodiment, the second light source 297 includes an ultra violet light source configured to illuminate an identifier viewable under ultra violet illumination, such as for example, an ultra violet seal, typically found on credit cards, pass ports, identification cards and currency.

In a preferred embodiment, the intelligent camera module 290 includes a detector module 291 configured with optical recognition which can include image recognition, character recognition, visual recognition, facial recognition, color recognition, shape recognition and the like. Advantageously, such optical recognition detecting, can be used to check against a reference file in memory 292, to confirm a threshold authenticity such that the optically recognized image matches the reference file. For example, the comparing step 340 compares to pre-determined like objects, which can provide an authenticity score, to ascertain whether a threshold score is met. Beneficially, optical recognition and authenticity scoring can improve counterfeit detection.

In one use case, the intelligent camera module 290 is configured with a processor 294, to calculate a score and display a result to a user real time. In more detail, in one embodiment, the intelligent camera module 290 is configured to provide a passing mode on the display 240, wherein a prompt indicates that the predetermined criteria has matched, and a failing mode indicating the predetermined criteria has not matched, presented on the display 240. In the case of the passing mode, a prompt can indicate it is appropriate to capture the second image, via display 240.

In another use case, the intelligent camera module 290 is configured to capture a third image, with the imager 295, of a purported owner of a passport, drivers license and identification card or currency. This provides a record of an imposter or currency counterfeiter, for record.

### Illustrative Example

1. A user of a phone takes a picture.

2. If the picture is of an ID or of currency, then a second picture is taken automatically with UV LED enabled in the flash.

3. If the picture is of an ID, then user is prompted to take a third picture of the ID holder (UV LED off).

4. Picture with UV LED is compared to norms and a valid/not-valid indication is given.

5. Picture of the user is compared to the ID picture and a % match score is given.

6. All pictures can be stored as evidence of policy enforcement.

The method and device herein can be customized by network personnel or a service provider, or by a user, to provide a unique user experience.

The device 200 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. An intelligent authentication method comprising:
capturing a first image of an object;
determining whether the object matches a predetermined criteria;
projecting ultra violet illumination at the object and capturing a second image of the object; and
comparing the second image to a reference file, to determine purported authenticity of the object.

2. The method of claim 1, wherein the object includes an identifier viewable under UV illumination.

3. The method of claim 1, wherein the object includes an ultra violet seal.

4. The method of claim 1, wherein the comparing step includes optical recognition.

5. The method of claim 1, wherein the comparing step includes calculating a score and displaying a result.

6. The method of claim 1, wherein the predefined criteria relates to at least one of a currency, a passport, a drivers license and an identification card.

7. The method of claim 1, wherein the predefined criteria relates to objects not being identified in the first image.

8. The method of claim 7, wherein a face is not identified in the first image.

9. The method of claim 1, further comprising providing a passing mode wherein a prompt indicates the predetermined criteria has matched.

10. The method of claim 1, further comprising providing a passing mode wherein a prompt indicates the predetermined criteria has matched and a failing mode indicating the predetermined criteria has not matched.

11. The method of claim 1, wherein the projecting ultra violet illumination step includes a focused flash.

12. The method of claim 1, wherein if the object is at least one of a passport, a drivers license and an identification card, further comprising capturing a third image of a purported owner of the at least one passport, drivers license and identification card.

13. The method of claim 1, wherein if the object is at least one of a passport, a drivers license and an identification card, further comprising prompting a user to focus the camera on the identification card owner.

14. The method of claim 1, wherein if the object is at least one of a passport, a drivers license and an identification card, further comprising automatically taking a picture when facial recognition acknowledges that a face is framed in the camera.

15. A wireless communication device, comprising:
a housing including a display;
a controller coupled to the housing, the controller configured to control the operations of a wireless communication device; and
an intelligent camera module including an imager, a light source and ultra violet light source, the intelligent camera module configured to: capture a first image of an object; determine whether the object matches a predetermined criteria; project ultra violet illumination at the object and capture a second image of the object; and compare the second image to a reference file, to determine purported authenticity of the object.

16. The device of claim 15, wherein the ultra violet light source is configured to illuminate an identifier viewable under ultra violet illumination.

17. The device of claim 15, wherein the intelligent camera module is configured to calculate a score and display a result.

18. The device of claim 15, wherein the predefined criteria relates to at least a face not being identified in the image.

19. The device of claim 15, wherein the intelligent camera module is configured to provide a passing mode wherein a prompt indicates the predetermined criteria has matched and a failing mode indicating the predetermined criteria has not matched, presentable on the display.

20. The device of claim 15, wherein the intelligent camera module is configured to capture a third image with the imager, of a purported owner of a document or currency.
